(19) United States
(12) Patent Application Publication
(10) Pub. No.: US 2019/0242423 A1
(43) Pub. Date: Aug. 8, 2019

(54) FASTENING SCREW AND TIGHTENING MANAGEMENT METHOD OF FASTENING SCREW

(71) Applicant: HONDA MOTOR CO., LTD., Tokyo (JP)

(72) Inventor: Masahiro Kamada, Wako-shi (JP)

(21) Appl. No.: 16/223,620

(22) Filed: Dec. 18, 2018

(30) Foreign Application Priority Data
Feb. 2, 2018 (JP) 2018-017435

(51) Int. Cl. F16B 31/02

(52) U.S. Cl. CPC F16B 31/02

(57) ABSTRACT

A problem is to provide a fastening screw with which an axial tension generated in a screw at a time of fastening is easily grasped, and the axial tension of the screw after fastening can be easily managed, even in a screw with a large diameter and a long length. The fastening screw includes a bore provided in a cylindrical portion through a head portion along an extending direction of the cylindrical portion, and a rod body that is inserted into the bore, has one end fixed to a bottom surface of the bore, and has an upper end protruded from the head portion. A protruded amount of the rod body from the head portion corresponds to an extension amount of the cylindrical portion at a time of generation of a predetermined axial tension.

### CROSS-REFERENCE TO RELATED APPLICATION

The present application claims priority under 35 U.S.C. § 119 to Japanese Patent Application No. 2018-017435 filed on Feb. 2, 2018, the entire contents of which are hereby incorporated by reference.

### BACKGROUND OF THE INVENTION

### Field of the Invention

The present disclosure relates to a screw for fastening and a fastening method of the screw.

### Description of the Related Art

There have been conventionally known a calibrated wrench tightening method, a torque gradient tightening method and the like as a tightening management method of a fastening screw.

The calibrated wrench tightening method estimates an axial tension of a screw by the tightening torque of the screw. For example, the calibrated wrench tightening method is performed by measuring the tightening torque by a torque wrench or the like. This uses the fact that the tightening torque of the screw is in a linear relationship with the axial tension of the screw.

Further, the torque gradient tightening method detects the tightening torque and a tightening rotation angle of a screw and performs management of tightening by a change in a gradient of the tightening torque to the tightening rotation angle. For example, there is also known a method that opens a bore along an axis of a bolt, inserts a distortion detector into the bore, and detects extension generated in the bolt (Japanese Patent Laid-Open No. 2005-91086).

### SUMMARY OF THE INVENTION

In the calibrated wrench tightening method, the tightening torque is influenced by a frictional force between a screw and a bearing surface, a frictional force in a thread groove and the like, so that when the method is used in a screw with a large diameter and a long length, a variation of the axial tension of the screw may increase even when the tightening torque of the screw is constant.

A screw with a large diameter and a long length has a large contact area of the screw and the bearing surface, and has a large contact area in the thread groove. Consequently, when the calibrated wrench tightening method is used, the screw with a large diameter and a long length easily causes a variation in the axial tension due to the influence by friction. Further, in a fine screw thread with a small pitch, a contact area of the screw and a fastened member increases, and the fine screw thread is easily influenced by friction.

Consequently, it is difficult to make the axial tensions required of a plurality of screws uniform. Further, when the axial tension of the screw is reduced after fastening, it is difficult to grasp an abnormality of the fastened portion.

Further, while the torque gradient tightening method is capable of managing the axial tension of the screw as in the method described in Japanese Patent Laid-Open No. 2005-91086, the structure of the screw itself is complicated. It is necessary to measure screw tensions by inserting detectors respectively into the screws, and connecting lead wires to the detectors. Further, it is necessary to recognize the values of the detectors connected to the respective screws by a dedicated apparatus.

Consequently, mounting work of the screws and management of the axial tensions are complicated.

In the light of the aforementioned conventional disadvantages, the present disclosure provides a fastening screw with which an axial tension generated in the screw at a time of fastening is easily grasped, and the axial tension of the screw after fastening can be easily managed even in a screw with a large diameter and a long length.

An aspect of the present disclosure includes a head portion and a cylindrical portion, a bore being provided in the cylindrical portion through the head portion along an extending direction of the cylindrical portion, and a rod body that is inserted into the bore, has one end fixed to a bottom surface of the bore, and has an upper end protruded from the head portion, wherein a protruded amount of the rod body from the head portion corresponds to an extension amount of the cylindrical portion at a time of generation of a predetermined axial tension.

According to the configuration, extension of the screw can be directly recognized, and the axial tension actually generated can be easily recognized. Further, by the shape of the head portion, generation of the predetermined axial tension is easily recognized at a time of fastening the screw. Further, fastening with a predetermined axial tension can be performed without using a management tool such as a torque wrench. Further, decrease and increase of the axial tension after fastening can be confirmed by visual observation.

Further, a surface parallel with the extending direction of the cylindrical portion, on the upper end of the rod body may be colored.

According to the configuration, at the time of fastening the screw, generation of the predetermined axial tension is easily recognized, and insufficiency of the axial tension of the screw is easily recognized.

Further, an inner circumferential surface at a head portion side, of the bore may be colored.

According to the configuration, at the time of fastening the screw, generation of the predetermined axial tension is easily recognized, and an excessive axial tension of the screw is easily recognized.

Another aspect of the present disclosure is such that a rod body is inserted into a bore provided in a cylindrical portion through a head portion along an extending direction of the cylindrical portion, one end of the rod body is caused to abut on a bottom surface of the bore, and based on positions of the other end of the rod body and the head portion, a fastened state is determined.

According to the configuration, extension of the screw can be directly recognized, and the axial tension actually generated can be easily recognized by ignoring a change in tightening torque due to a frictional force or the like.

According to the present disclosure, extension of the screw is directly recognized, and the axial tension actually generated can be easily recognized. Further, fastening with a predetermined axial tension can be performed without using a management tool such as a torque wrench. Furthermore, a decrease and an increase in the axial tension after fastening can be confirmed by visual observation.

Thereby, a fastening screw can be provided, with which the axial tension generated in the screw at the time of fastening is easily grasped, and the axial tension of the screw after fastening can be easily managed, even in a screw with a large diameter and a long length.

### BRIEF DESCRIPTION OF THE DRAWINGS

FIG. 1 is a sectional view illustrating a configuration of a screw of embodiment 1;

FIG. 2 is a perspective view illustrating a state of a display portion corresponding to an axial tension; and

FIG. 3 is a sectional view illustrating a modified example of a rod body tip end.

### DETAILED DESCRIPTION OF THE PREFERRED EMBODIMENT

### Embodiment 1

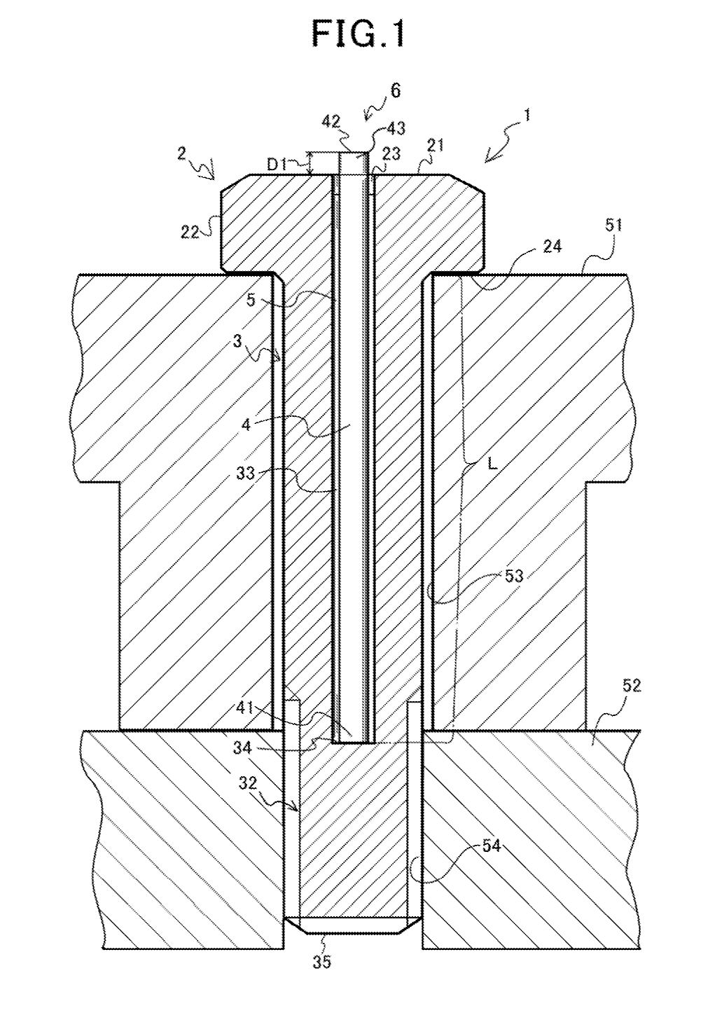

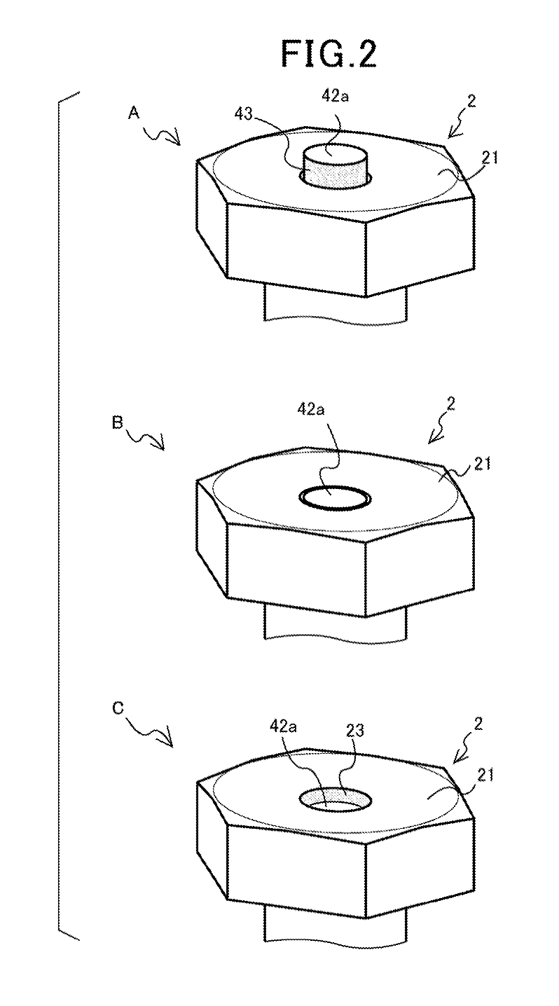

A fastening screw 1 according to a first embodiment of the present disclosure will be described with use of FIGS. 1 and 2.

FIG. 1 is a sectional view illustrating a configuration of a fastening screw of embodiment 1, and FIG. 2 is a perspective view illustrating a state of a display portion corresponding to an axial tension.

First, an entire configuration of a fastening screw 1 according to the first embodiment of the present disclosure will be described.

In FIG. 1, the fastening screw 1 is configured by a head portion 2, a cylindrical portion 3, and a rod body 4 that is inserted into the head portion 2 and the cylindrical portion 3. Note that in the present embodiment, as an example of the fastening screw 1, a hexagon head bolt is used.

The fastening screw 1 is a male screw, has the cylindrical portion 3 inserted to a through hole 53 of a fastened member 51, which is one member to be fastened, and screwed onto a female screw portion 54 of a fastened member 52, which is the other member to be fastened. Thus, the fastening screw 1 generates an axial tension in the cylindrical portion 3 and fastens the fastened member 51 and the fastened member 52.

The head portion 2 configuring an upper portion of the fastening screw 1 is configured into a hexagonal column shape, and a tightening tool such as a wrench is fitted to a side surface of the head portion 2 and transmits tightening torque to the fastening screw 1.

At a lower portion of the head portion 2, the cylindrical portion 3 in a columnar shape is extended downward. The cylindrical portion 3 is configured by a columnar body with a uniform outside diameter.

At a lower end of the cylindrical portion 3, a thread groove is cut on an outer circumferential surface of the cylindrical portion 3, and a screw portion 32 is formed by the thread groove. The screw portion 32 is provided from a middle portion of the cylindrical portion 3 to the lower end.

In the fastening screw 1, in the head portion 2 and the cylindrical portion 3, a linear insertion bore 33 is formed along an extending direction of the cylindrical portion 3. The insertion bore 33 is provided from a top surface 21 of the head portion 2 to the middle portion in the cylindrical portion 3, and a bottom surface 34 of the insertion bore 33 is located inside of an upper part of the screw portion 32.

The insertion bore 33 is provided in a center portion of the fastening screw 1, and is provided along a center portion in the cylindrical portion 3 through a center portion of the top surface 21 of the head portion 2.

Note that a position of the bottom surface 34 of the insertion bore 33 is arbitrarily determined by a length of the cylindrical portion 3 of the fastening screw 1 and a length of the screw portion 32, and is not specified to the present embodiment.

The rod body 4 is inserted into the insertion bore 33, and a lower end portion 41 of the rod body 4 is fixed to a center of the bottom surface 34 of the insertion bore 33.

For example, resistance spot welding can be used as a means for fixing the rod body 4 in the insertion bore 33 of the fastening screw 1. In this case, the rod body 4 is pressed against the bottom surface 34 of the insertion bore 33, and an appropriate pressing force is applied between the rod body 4 and the bottom surface 34 by pressurizing the upper end portion 42 of the rod body 4 and the lower end portion 35 of the fastening screw 1. Then, an electric current flows between the rod 4 and the bottom surface 34, and they are melted and adhered to each other by Joule heat generated in the contact resistance.

The rod body 4 is a linear rod in a columnar shape, and an entire length of the rod body 4 is longer than an entire length of the insertion bore 33.

Therefore, in a state in which the lower end portion 41 of the rod body 4 is fixed to the bottom surface 34 of the insertion bore 33, an upper end portion 42 of the rod body 4 protrudes from the top surface 21 of the head portion 2 of the fastening screw 1.

Further, an outside diameter of the rod body 4 is smaller than an inside diameter of the insertion bore 33, and is configured so that a gap 5 is formed between the rod body 4 and an inner circumferential surface of the insertion bore 33. Thereby, the rod body 4 hardly contacts an inner surface of the insertion bore 33.

A display portion 6 is configured by the upper end portion 42 of the rod body 4, the top surface 21 of the head portion 2, and the inner surface of the insertion bore 33.

A first display portion 43 is provided at a site protruded from the insertion bore 33, of the upper end portion 42 of the rod body 4. The first display portion 43 is configured by coloring a fixed region downward of a top surface 42a, of the outer circumferential surface of the upper end portion 42 of the rod body 4.

A second display portion 23 is provided by coloring an inner circumferential surface of the insertion bore 33 to a fixed depth from the top surface 21 of the head portion 2.

The display portion 6 is configured by the first display portion 43 and the second display portion 23.

Note that as an example, the display portion 6 is made easily recognizable by visual observation by coloring the first display portion 43 red, and the second display portion 23 yellow.

Further, by using colors at a long wavelength side of red and yellow, visibility from a long distance can be enhanced.

A protruded amount D1 from the top surface of the upper end portion 42 of the rod body 4 is configured so that the top surface 21 of the head portion 2 and the top surface 42a of the rod body 4 correspond to each other when an appropriate axial tension is generated in the fastening screw 1.

When an axial tension is generated in the fastening screw 1, the fastening screw 1 extends in an axial direction. However, the rod body 4 has one end fixed to the bottom surface 34 of the insertion bore 33, and is not influenced by the axial tension. Consequently, the rod body 4 keeps a fixed length irrespective of extension of the fastening screw 1.

It becomes possible to recognize extension of the fastening screw 1, that is, the axial tension, based on a position of the upper end portion 42 of the rod body 4 to the head portion 2 of the fastening screw 1.

The protruded amount D1 is determined by a relationship between the extension amount of the cylindrical portion 3 and the axial tension. In more detail, the protruded amount D1 is determined by a relationship between an extension amount of a portion L from an undersurface 24 of the head portion 2 to the bottom surface 34 of the insertion bore 33 in the cylindrical portion 3 and the axial tension.

The cylindrical portion 3 extends, and thereby, a distance between the bottom surface 34 to which the rod body 4 is fixed and the undersurface 24 of the head portion 2 increases. Since the head portion 2 does not extend by the axial tension, a distance between the top surface 21 and the undersurface 24 is constant.

Thereby, the extension amount of the portion L is found from a change amount of the positions of the top surface 21 of the head portion 2 and the top surface 42a of the rod body 4. Therefore, the protruded amount D1 is determined in accordance with the extension amount of the portion L that generates an appropriate axial tension.

Next, an operation of the present embodiment will be described with reference to FIG. 2.

In FIG. 2, a state A shows a state in which the fastening screw 1 is in an unfastened state, or a state in which the axial tension of the fastening screw 1 is insufficient. A state B shows a state in which fastening of the fastening screw 1 is completed, and the appropriate axial tension is generated. A state C shows a state in which the fastening screw 1 is excessively fastened, and an excessive axial tension is generated.

When the fastening screw 1 is unfastened or when the axial tension is insufficient, as shown in the state A, the upper end portion 42 of the rod body 4 protrudes from the top surface 21 of the head portion 2, and the first display portion 43 can be recognized by visual observation or the like from outside of the fastening screw 1.

When fastening of the fastening screw 1 is completed and the appropriate axial tension occurs as shown in the state B, the first display portion 43 of the rod body 4 is buried, and a height of the top surface 42a of the rod body 4 corresponds to the top surface 21 of the head portion 2. Consequently, the first display portion 43 is hidden in the insertion bore 33, and cannot be recognized by visual observation or the like from outside of the fastening screw 1.

When the fastening screw 1 is excessively fastened, and an excessive axial tension occurs as shown in the state C, the first display portion 43 of the rod body 4 is further buried, and the height of the top surface 42a of the rod body 4 is lower than the top surface 21 of the head portion 2. Consequently, the second display portion 23 in the insertion bore 33 is exposed, and can be recognized by visual observation or the like from outside of the fastening screw 1.

Further, difference in color between the first display portion 43 and the second display portion 23 makes it recognizable which one is exposed.

As described above, in the present embodiment, in the fastening screw 1, the rod body 4 is inserted into the insertion bore 33, the lower end portion 41 of the rod body 4 is fixed to the bottom surface 34 of the insertion bore 33, and the upper end portion 42 of the rod body 4 is protruded by the protruded amount D1. Thereby, extension of the fastening screw 1 can be directly recognized, and the axial tension that is actually generated can be easily recognized.

Further, by the shape of the upper portion of the head portion 2, it is easily recognized whether the predetermined axial tension is generated or not.

Further, fastening with the predetermined axial tension can be performed without using a management tool such as a torque wrench. Further, a decrease and an increase of the axial tension after fastening can be confirmed by visual observation.

Next, a modified example of the rod body 4 in the present disclosure will be described.

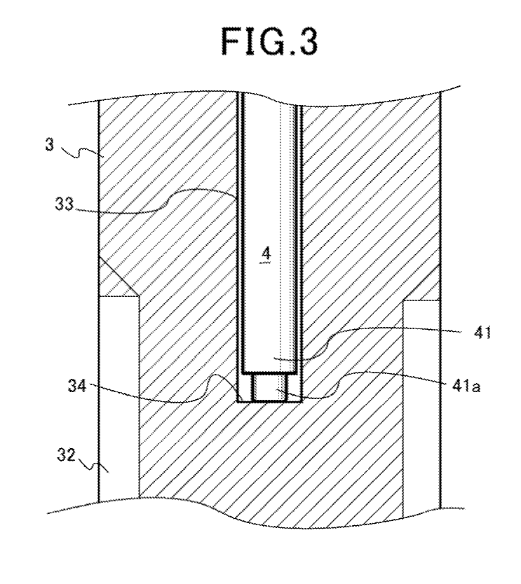

FIG. 3 is a sectional view illustrating a modified example of a rod body tip end.

A small diameter portion 41a is provided at the lower end portion 41 of the rod body 4 that is inserted into the fastening screw 1. In the small diameter portion 41a, a sectional shape orthogonal to the extending direction of the rod body 4 is in a circular shape with a small diameter as compared with other sites of the rod body 4. An outside diameter of the small diameter portion 41a may be two thirds of an outside diameter of the rod body 4. The small diameter portion 41a of the rod body 4 is fixed to the bottom surface 34 of the insertion bore 33.

As means for fixing the rod body 4 into the insertion bore 33 of the fastening screw 1, resistance welding can be used. In this case, the rod body 4 is pressed against the bottom surface 34 of the insertion bore 33, and an appropriate pressing force is applied between the small diameter portion 41a of the rod body 4 and the bottom surface 34. A current is passed to between the small diameter portion 41a of the rod body 4 and the bottom surface 34, and the small diameter portion 41a of the rod body 4 and the bottom surface 34 are melted and bonded to each other by Joule's heat generated in the contact resistance.

By pressing the small diameter portion 41a of the rod body 4 against the bottom surface 34, an appropriate pressing force can be obtained with a smaller force, because an undersurface of the small diameter portion 41a is small. When a current is passed, a current concentrates on a small section of the small diameter portion 41a, and a volume of the site which is melted is small. Consequently, as compared with a case without the small diameter portion 41a, the rod body 4 can be fixed to the bottom surface 34 of the insertion bore 33 with smaller power, and sites other than the small diameter portion 41a become difficult to melt.

Thereby, even when the rod body 4 is fixed to the fastening screw 1 by spot welding, variation in the length of the rod body 4 by welding is restrained, and mounting precision of the rod body 4 can be enhanced. Measurement precision of extension of the cylindrical portion 3 can be enhanced, and determination precision of the fastening state of the fastening screw 1 can be enhanced.

The aforementioned embodiment only illustrates one aspect of the present disclosure, and can be modified and applied arbitrarily within the range without departing from the scope of the present disclosure.

### REFERENCE SIGNS LIST

1 Fastening screw
2 Head portion
3 Cylindrical portion
4 Rod body
5 Gap
21 Top surface
23 Second display portion
24 Undersurface
32 Screw portion
33 Insertion bore
34 Bottom surface
41 Lower end portion
41a Small diameter portion
42 Upper end portion
42a Top surface
43 First display portion

What is claimed is:

1. A fastening screw comprising:
a head portion and a cylindrical portion, a bore being provided in the cylindrical portion through the head portion along an extending direction of the cylindrical portion; and
a rod body that is inserted into the bore, has one end fixed to a bottom surface of the bore, and has an upper end protruded from the head portion,
wherein a protruded amount of the rod body from the head portion corresponds to an extension amount of the cylindrical portion at a time of generation of a predetermined axial tension.

2. The fastening screw according to claim 1,
wherein a surface parallel with the extending direction of the cylindrical portion, on the upper end of the rod body is colored.

3. The fastening screw according to claim 1,
wherein an inner circumferential surface at a head portion side, of the bore is colored.

4. The fastening screw according to claim 2,
wherein an inner circumferential surface at a head portion side, of the bore is colored.

5. A tightening management method of a fastening screw,
wherein a rod body is inserted into a bore provided in a cylindrical portion through a head portion along an extending direction of the cylindrical portion,
one end of the rod body is caused to abut on a bottom surface of the bore, and
based on positions of the other end of the rod body and the head portion, a fastened state is determined.
